(19) United States
(12) Patent Application Publication
(10) Pub. No.: US 2011/0086556 A1
(43) Pub. Date: Apr. 14, 2011

(54) ELECTRICAL CONNECTOR WITH CAM ACTUATED LOCKING MECHANISM

(76) Inventors: Milton B. Hollander, Stamford, CT (US); Michael A. Macchiarelli, Shelton, CT (US)

(21) Appl. No.: 12/900,660

(22) Filed: Oct. 8, 2010

Related U.S. Application Data
(60) Provisional application No. 61/278,786, filed on Oct. 10, 2009.

(51) Int. Cl. H01R 13/42

(52) U.S. Cl. 439/733.1

(57) ABSTRACT

A connector assembly includes a housing defining an interior area therein. The housing has one or more mounting portions disposed in the interior area. The connector assembly includes one or more terminals having a first securing portion thereon. At least a portion of the terminal is disposed in the interior area. One or more clamping members are disposed in the housing, each of the clamping members define a coupling portion and a second securing portion thereon. The coupling portion is in electrical communication with the terminal. The connector assembly includes one or more locking mechanisms defining a cam portion which is pivotally coupled to one or more of the mounting portions. The cam portion engages the clamping portion so that a lead of a wire is releasably secured between the first and second securing portions.

### FIELD OF THE INVENTION

The present invention relates generally to electrical connectors for coupling leads from wires, wire ribbon and the like, to signal and/or power terminals, and more specifically to an electrical connector having a cam actuated locking mechanism for removably coupling the leads to the connector.

### BACKGROUND OF THE INVENTION

Electrical connectors are used for activating and deactivating the transmission of electrical signals and/or electrical current in an electrical circuit. The electrical connectors generally include at least two terminal portions, namely 1) a connector-to-connector terminal portion; and 2) a connector-to-conductor terminal portion. The connector-to-connector terminal portion provides releasable engagement between two or more of the electrical connectors. A plug and an electrical socket used for connecting a power supply to an appliance are examples of connector-to-connector terminals.

The connector-to-conductor terminal portion provides releasable engagement between the electrical connector and a conductor such as solid wire, braided wire and wire ribbon. The conductor is usually encased in a dielectric material to prevent short circuiting of the electrical signals and/or electrical current during the transmission of the electrical signal and/or current. The dielectric also helps protect people from electric shock in the event that they come into contact with the conductor.

Typically, the conductor is coupled to the connector-to-conductor terminal by a threaded fastener, such as a screw threaded into the connector-to-conductor terminal For example, a portion of the dielectric can be stripped off the conductor to create an exposed end portion of thereof, which can be bent and wrapped around the screw of the terminal. The screw can be tightened, thereby securing the conductor between a head portion of the screw and a connector-to-conductor terminal. The connector-to-conductor terminal, screw and exposed end portion of the conductor are generally contained within a dielectric housing.

Bending and twisting the exposed end of the conductor around the screw and then tightening the screw can be a labor intensive effort. Moreover, the exposed end of the conductor can become completely or partially dislodged from under the screw head during tightening, thereby deteriorating electrical conductivity between the connector-to-conductor terminal and the conductor.

### SUMMARY OF THE INVENTION

According to aspects illustrated herein, there is provided a connector assembly that includes a housing defining an interior area therein. The housing has one or more mounting portions disposed in the interior area. The connector assembly includes one or more terminals having a first securing portion thereon. At least a portion of the terminal is disposed in the interior area. One or more clamping members are disposed in the housing and each of the clamping members define a coupling portion and a second securing portion thereon. The coupling portion is in electrical communication with the terminal. The connector assembly includes one or more locking mechanisms defining a cam portion which is pivotally coupled to one or more of the mounting portions. The cam portion engages the clamping portion so that a lead of a wire is releasably secured between the first and second securing portions.

According to other aspects illustrated herein, the locking mechanism includes an actuator portion which is configured to be moved by a user between an engaged position in which the lead is secured between and in electrical communication with the first and second securing portions and a disengaged position in which the lead is releasable from between the first and second securing portions.

According to other aspects illustrated herein, the housing includes a first housing section having one or more fasteners extending therefrom and a second housing section having one or more fasteners extending therefrom. The first and second fasteners cooperate to releasably secure the first and second housing sections to one another.

According to other aspects illustrated herein, the first housing portion defines one or more seats extending therefrom and the second housing portion defines one or more seats extending therefrom. The locking member includes at least one shaft extending from the cam portion. The shaft is pivotally mounted between the respective seats of the first and second housing sections.

According to other aspects illustrated herein, one of the first and second housing portions defines an opening extending therethrough and through which the actuator portion extends.

The above described and other features are illustrated by the following figures and detailed description.

### BRIEF DESCRIPTION OF THE DRAWINGS

Referring now to the Figures, which are exemplary embodiments, and wherein the like elements are numbered alike:

FIG. 1 is a perspective view of an electrical connector;

FIG. 2 is an exploded view of the electrical connector of FIG. 1;

FIG. 3 is a plan view of a locking mechanism;

FIG. 4 is a perspective view of a first housing section of the electrical connector of FIG. 1;

FIG. 5 is a perspective view of a second housing section of the electrical connector of FIG. 1;

FIG. 6 is side partial cross sectional view of the electrical connector of FIG. 1, shown in a disengaged configuration;

FIG. 7 is a perspective view of the electrical connector of FIG. 6;

FIG. 8 is a side partial cross sectional view of electrical connector of FIG. 1, shown in an engaged configuration;

FIG. 9 is a perspective view of the electrical connector of FIG. 8; and

FIG. 10 is a plan view of a multi-part locking mechanism.

### DETAILED DESCRIPTION OF THE PREFERRED EMBODIMENTS

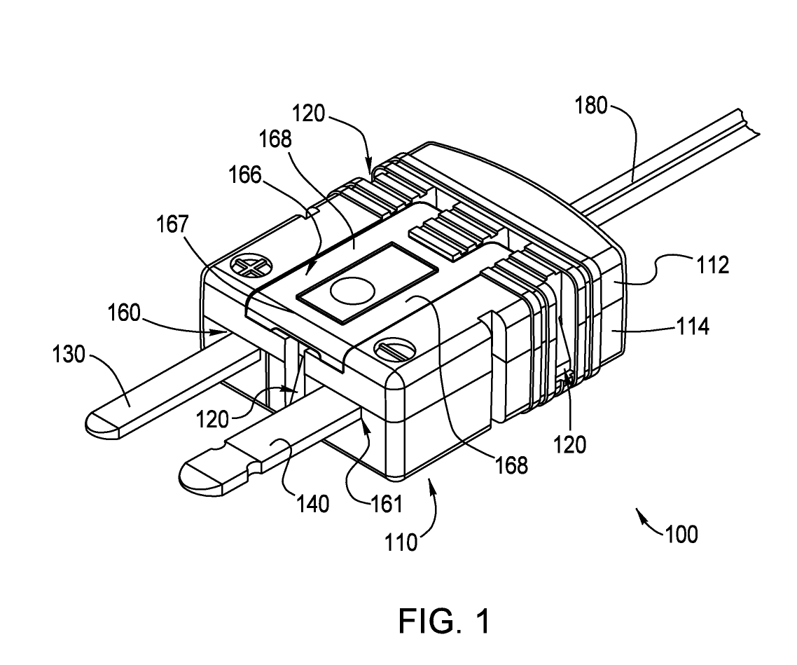

In FIG. 1, an electrical connector assembly 100 is presented. The electrical connector assembly 100 includes a housing 110 having a first housing portion 112 releasably coupled to a second housing portion 114 by a plurality of fasteners, for example, three clips 120. One or more signal and/or power terminals, for example two signal and/or power terminals 130 and 140, extend from openings 160 and 161, in the housing 110, respectively. The signal and/or power terminals 130 and 140 are removably secured between the first and second housing portions 112 and 114. As described herein, the electrical connector assembly 100 includes a locking mechanism 166 which removably couples a wire 180 and leads thereof to the signal and/or power terminals 130 and 140, as described below. In one embodiment, the electrical connector assembly 100 mates with a second connector or connector assembly (not shown) for providing electrical or signal communication therebetween. In one embodiment, the housing 110 is manufactured from a dielectric material and the signal and/or power terminals are manufactured from an electrical conductor or semiconductor.

While the electrical connector assembly 110 is shown and described as having two signal and/or power terminals 130 and 140 extending from the housing 110, the present invention is not limited in this regard as other configurations can be employed, including but not limited to, any number of signal and/or power terminals extending from or setback into the openings 160 and 161 and/or secured between the first and second housing portions 112 and 114. Although the first and second housing portions 112 and 114 are shown and described as being releasably coupled to one another by three clips 120, the present invention is not limited in this regard as any number of fasteners of any suitable type may be employed without departing from the broader aspects of the invention.

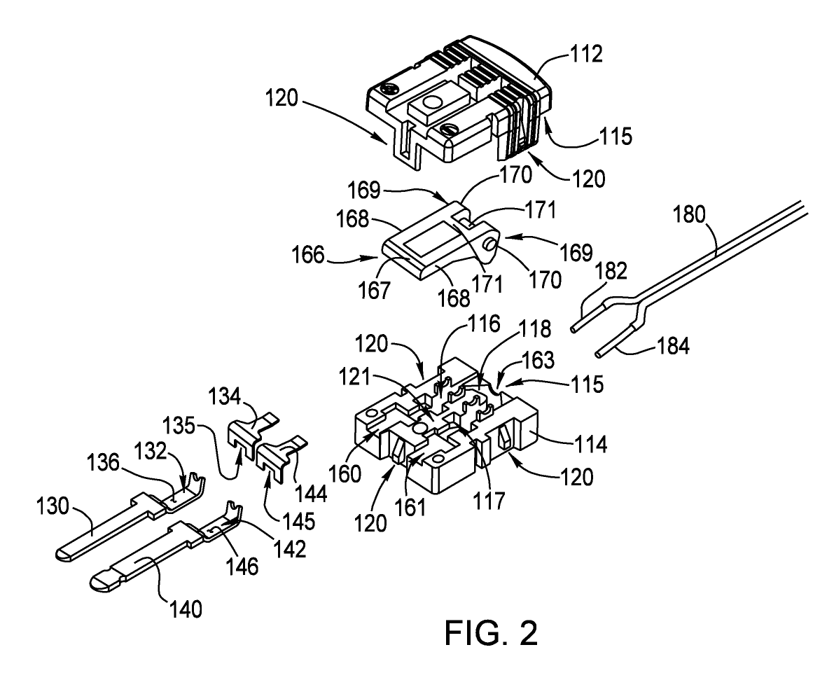

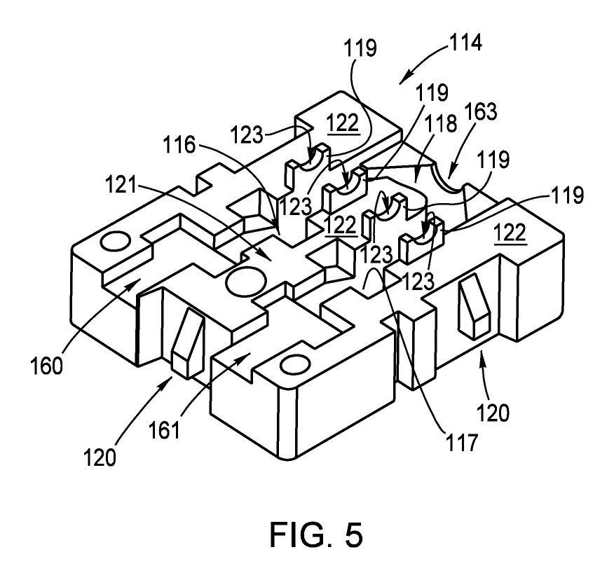

As shown in FIG. 2, the housing 110 includes an interior area 115 defined by the first and second housing portions 112 and 114, for receiving a portion of the signal and/or power terminals 130 and 140 and the wire 180. As shown in FIGS. 2 and 5, the second housing portion 114 includes two interconnected cavities 116 and 117 recessed therein. The first cavity 116 extends from the opening 160 to a wire receiving portion 118 recessed in the second housing portion 114. The second cavity 117 extends from the opening 161 to the wire receiving portion 118. The wire receiving portion 118 includes an opening 163 for receiving the wire 180 therethrough. Portions of the first and second cavities 116 and 117 are separated apart from one another by a dielectric barrier 121.

Still referring to FIGS. 2 and 5, the second housing portion 114 includes a plurality of posts, for example, four posts 119, extending substantially perpendicularly from a mating surface 122 of the second housing portion. Each of the posts 119 define mounting portion, for example, a semi-circular seat 123 formed on a distal end of each post, for receiving and pivotally supporting a locking mechanism as described below.

Referring to FIGS. 2, 5 and 6, the signal and/or power terminal 130 defines a securing portion 132 thereon, for receiving a lead 182 of the wire 180; and the signal and/or power terminal 140 defines a securing portion 142 thereon, for receiving another lead 184 of the wire 180. A clamping member 134 is disposed on the signal and/or power terminal 130; and a clamping member 144 is disposed on the signal and/or power terminal 140. The clamping member 134 defines a seat section 135 which is in electrical communication with the securing portion 132; and the clamping member 144 defines a seat section 145 which is in electrical communication with the securing portion 142. In one embodiment, the clamping members 134 and 144 are manufactured from resilient conductive material which allows for elastic deformation thereof between a disengaged position and an engaged position, as described below. While the securing portions 132, 142 are shown and described as having the clamping members 134, 144 disposed thereon, the present invention is not limited in this regard as the clamping members can be formed integrally with and extend from the signal and/or power terminals 130, 140, respectively.

When the electrical connector assembly 100 is assembled as shown in FIGS. 2 and 6-9, the securing portion 132 of the signal and/or power terminal 130 is disposed in the first cavity 116, and the securing portion 142 of the signal and/or power terminal 140 is disposed in the second cavity 117. The first lead 182 of the wire 180 extends through the opening 163 and the wire receiving portion 118, is disposed in the first cavity 116 and rests upon a surface 136 of the securing portion 132. The second lead 184 of the wire 180 extends through the opening 163 and the wire receiving portion 118, is disposed in the second cavity 117 and rests upon a surface 146 of the securing portion 142. The clamping member 134 of the signal and/or power terminals 130 is disposed about the first lead 182, and the clamping member 144 of the signal and/or power terminals 140 is disposed about the second lead 184. It should be appreciated that in one embodiment, the clamping members 134 and 144 are already disposed in proximity to the securing portions 132 and 142 such that as the leads 182 and 184 of the wire 180 are placed in the cavities 116 and 117, respectively, the leads 182 and 184 are accepted between and received by the respective securing portions 132, 142 and clamping members 134, 144 of the signal and/or power terminals 130 and 140.

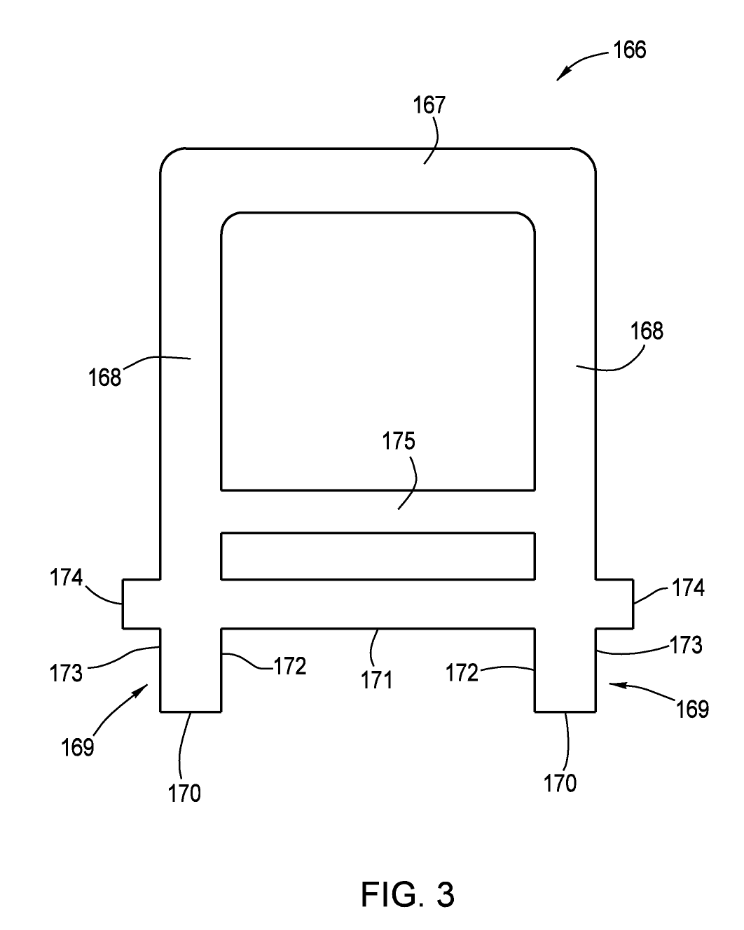

Referring to FIGS. 2 and 3, a locking mechanism 166 includes an actuator, for example, a handle portion 167 having two legs 168 extending therefrom. Each of the legs 168 terminates in a cam portion 169 defining a cam surface 170 thereon. Each of the cam surfaces 170 extend between an inwardly facing surface 172 and an opposing outwardly facing surface 173 of the each of the cam portions 169. The locking mechanism 166 includes a substantially cylindrical shaft 171 extending between the inwardly facing surfaces 172. In addition, a shaft, for example a substantially cylindrical stud 174 projects substantially perpendicularly from each of the outwardly facing surfaces 173. The shaft 171 and the studs 174 are generally coaxially with one another. The locking mechanism 166 also includes a support member 175 extending between the legs 168 at an intermediate position between the handle portion 167 and the shaft 171.

For ease of manufacturing the locking mechanism 166 is manufactured as one integral piece including the handle portion 167, the legs 168, the cam portion 169, the shaft 171, the studs 174 and the support member 175. Although the locking mechanism is shown and described as being one integral piece, the present invention is not limited in this regard as other configurations can be employed including but not limited to the handle portion 167, the legs 168, the cam portion 169, the shaft 171, the studs 174 and support member 175 being provided separately and assembled together to form the locking mechanism and the shaft and studs being provided as a common piece and disposed in bores formed in the cam portion.

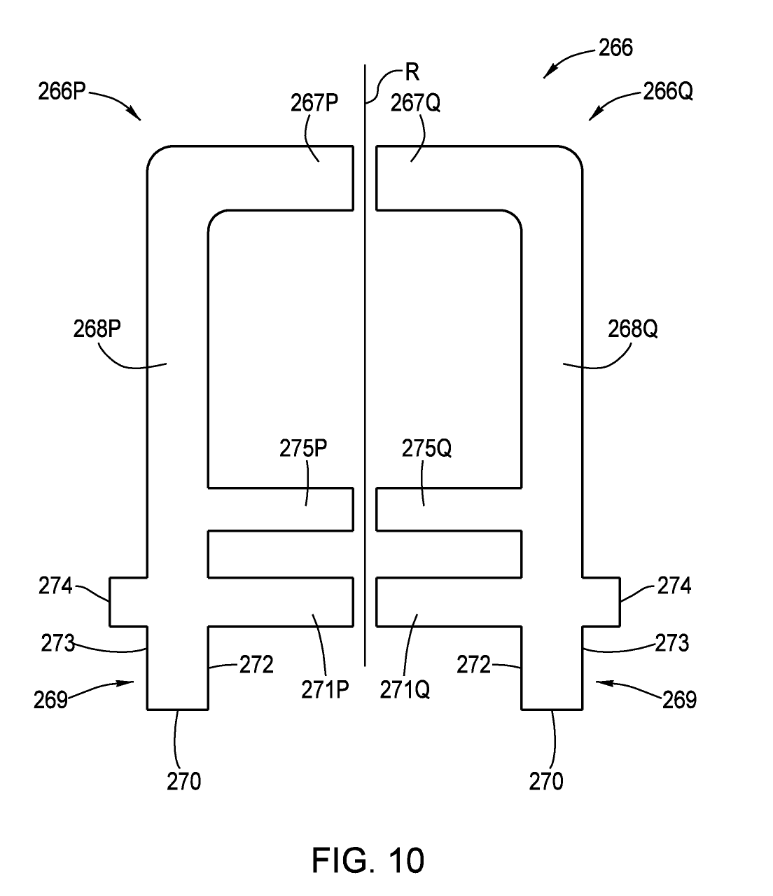

In one embodiment, as shown in FIG. 10, a multi-part part locking mechanism, for example, a two part locking mechanism 266 similar to the locking mechanism 166 of FIG. 3 is presented. Therefore, elements in FIG. 10 which are similar to the respective elements in FIG. 3 are assigned numbers similar to those used in FIG. 3, but have the first digit replaced by the number 2. In addition, elements which have been separated into two parts have a suffix (i.e., P or Q) added to the element numbers. The two part locking mechanism 266 is separated into a first section 266P and a second section 266Q, generally along the reference line designated R. In particular, the locking mechanism 266 includes a first and second handle section 267P and 267Q; a first and second leg 268P and 268Q; a first and second shaft 271P and 271Q; a first and second support member 275 P and 275Q. The first and second sections 266P and 266Q can move independent of one another and are otherwise configured similar to the locking mechanism 166 described above.

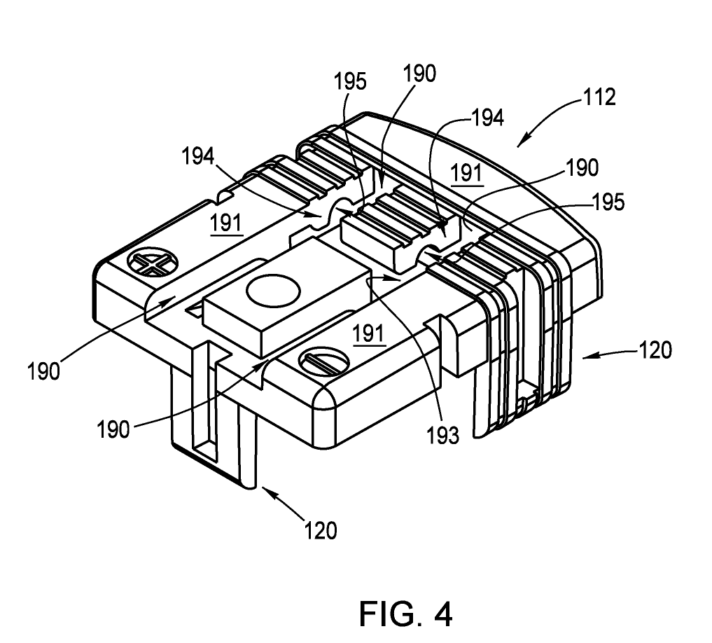

Referring to back to FIG. 4, the first housing portion 112 defines a channel 190 recessed into an outwardly facing surface 191 of the first housing portion for receiving the handle portion 167 and the legs 168 of the locking mechanism 166 when the locking mechanism is in the engaged position. A portion of the channel 190 extends through the first housing portion 112 defining an opening 193 therethrough. The opening 193 is configured to allow the handle portion 167 and legs 168 to pass therethrough. In addition, three shaft caps 194 (only two shaft caps are shown) are recessed into an inwardly facing portion of the first housing portion 112 and are separated from one another by the channel 190.

Referring to FIGS. 2-6 and 8, each of the shaft caps 194 include a semi-circular seating portion 195 which cooperate with the semi-circular seats 123 to pivotaly secure the shaft 171 and/or the studs 174 therebetween. In particular, the seating portion 195 of each of the two outermost of the shaft caps 194 cooperate with the seating portion 123 of the respective outermost posts 119 to pivotally secure the studs 174 therebetween; and the seating portion 195 of the shaft cap 194 positioned between the two outer most shaft caps cooperates with both of the seating portions 123 of the two posts 119 positioned between the outermost posts, to pivotally secure the shaft 171.

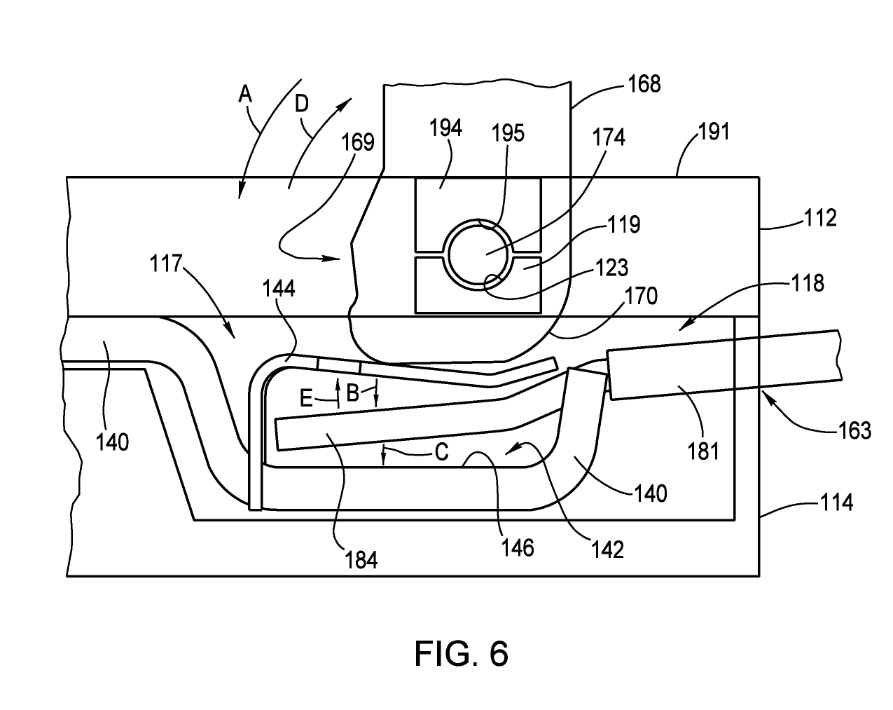

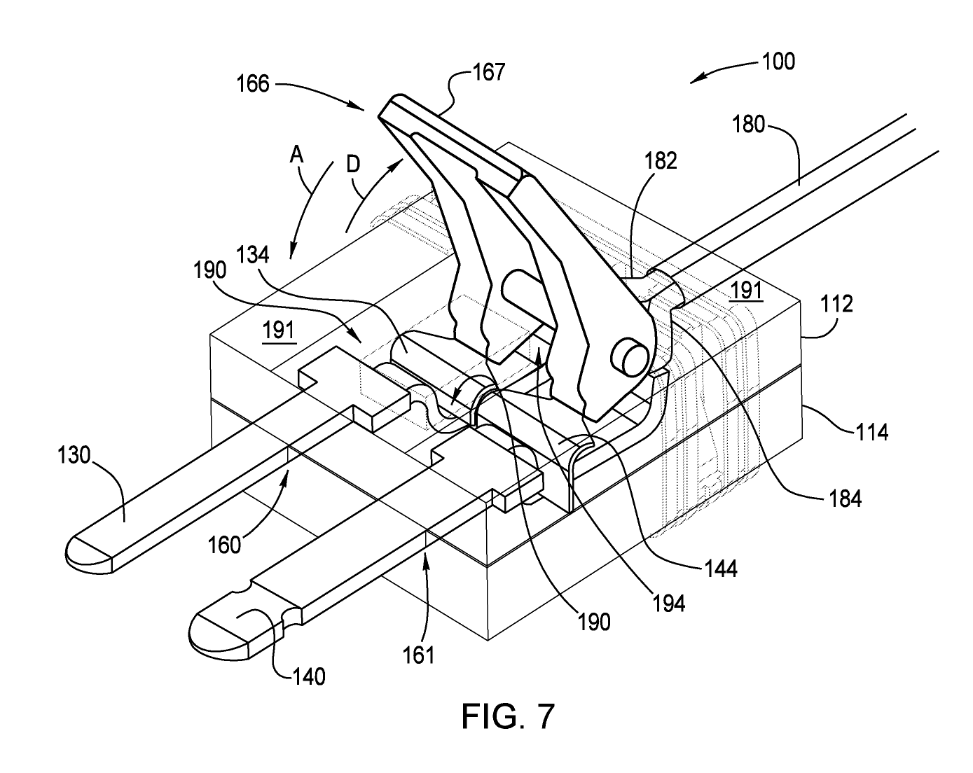

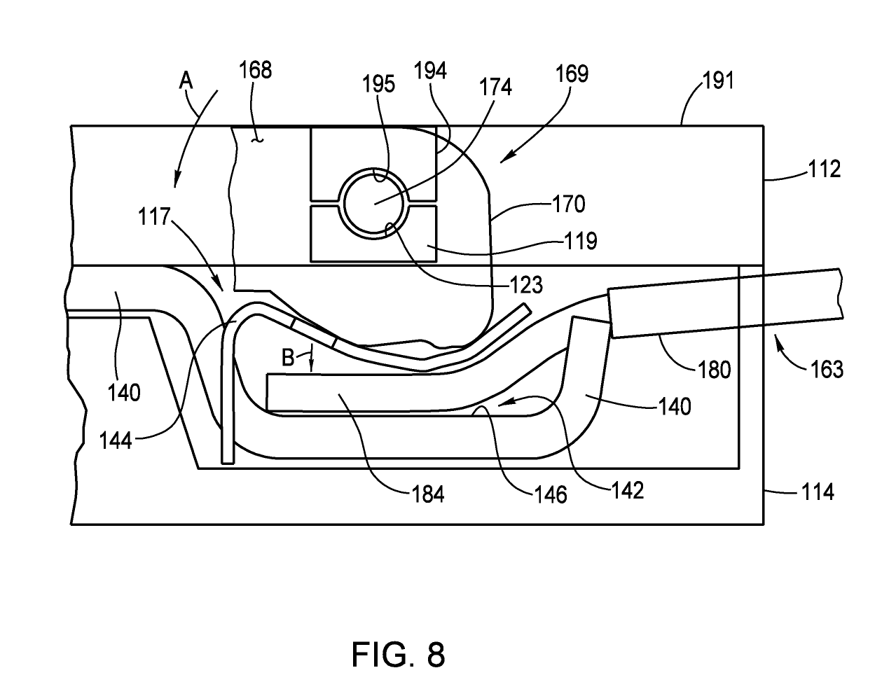

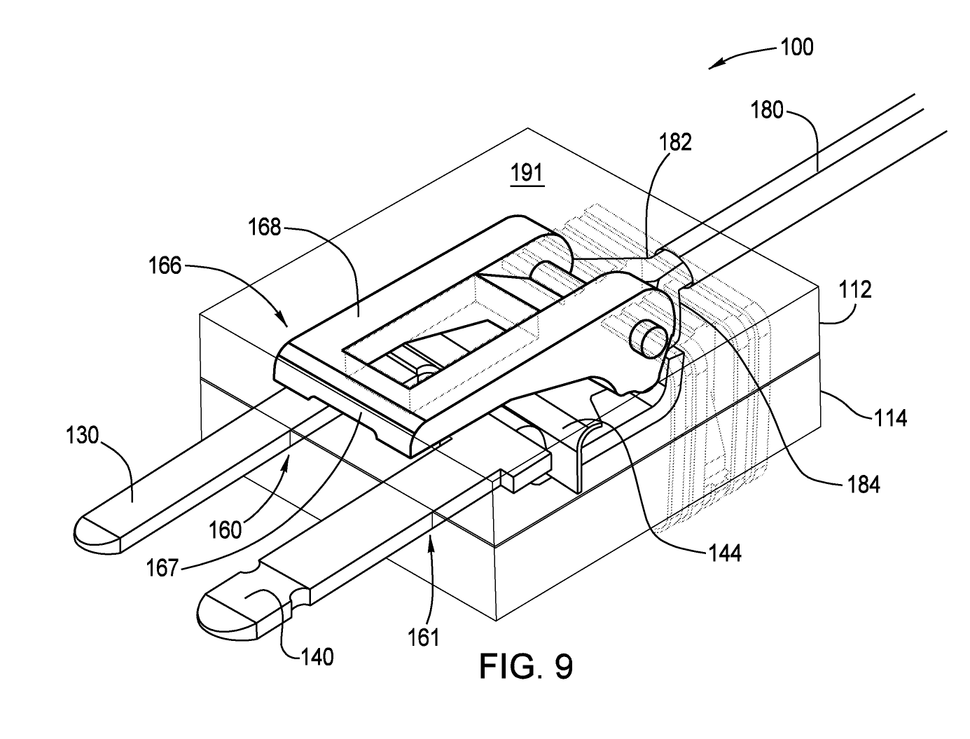

The cam portion 169 of the locking mechanism 166 is disposed within the housing 110, as described above and is selectively pivotable therein, between the disengaged position (depicted in FIGS. 6 and 7) and the engaged position (depicted in FIGS. 8 and 9) by, for example, operation of the handle portion 167. As the handle portion 167 is moved in a direction indicated by arrow A toward the engaged position, each of the cam portions 169 exerts a force on the respective clamping member 134 and 144 in the general direction indicated by the arrow B. Application of the force causes the clamping members 134 and 144 to elastically deflect from a relaxed position and engage the leads 182 and 184, respectively. The force transmitted through the clamping members 134 and 144 causes the leads 182 and 184 to deflect in the general direction indicated by the arrow C, against the securing portions 132 and 142 of the signal and/or power terminals 130 and 140, respectively.

Referring to FIGS. 8 and 9, in an engaged position, portions of the handle 167 and legs 168 are recessed into the channel 190. The locking mechanism 166 is releasably locked in the engaged position by engagement of portions of the cam surfaces 170 with portions of the clamping members 134 and 144. When in the engaged position, the lead 182 is secured between and is in electrical communication with the securing portion 132 and the clamping member 134; and the lead 184 is secured between and is in electrical communication with the securing portion 142 and the clamping member 144. For clarity in FIG. 8, the cam surface 170, the clamping member 144, the lead 184 and the surface 146 of the securing portion 142 are shown in proximity, but not in contact. It should be appreciated that in the engaged position, these elements are in contact.

Referring to FIGS. 6 and 7, when the handle 167 is moved in the general direction indicated by the arrow D out of the channel 190 and towards the disengaged position, the cam surfaces 170 release the force applied to the respective clamping members 134 and 144. Such movement of the handle 167 allows the clamping members 134 and 144 to move away from the respective securing portions 132 and 142 in the direction generally indicated by the arrow E and back to the relaxed position. In the disengaged position, the leads 182 and 184 are no longer engaged and can be retracted from or inserted into the housing 110.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

What is claimed is:

1. A connector assembly, comprising:
a housing defining an interior area therein, said housing having at least one mounting portion disposed in said interior area;
at least one terminal defining a first securing portion thereon, at least a portion of said at least one terminal being disposed in said interior area;
at least one clamping member disposed in said housing, said at least one clamping member defining a coupling portion and a second securing portion thereon, said coupling portion being in electrical communication with said at least one terminal;
at least one locking mechanism defining a cam portion, said cam portion being pivotally coupled to said mounting portion; and
said cam portion engaging said clamping portion so that a lead of a wire is releasably secured between said first and second securing portions.

2. The connector assembly of claim 1, wherein said housing includes a first housing section having at least one first fastener extending therefrom and a second housing section having at least one second fastener extending therefrom, said first and second fasteners cooperating to releasably secure said first and second housing sections to one another.

3. The connector assembly of claim 1, wherein another portion of said at least one terminal extends outwardly from said housing.

4. The connector assembly of claim 1, wherein said locking mechanism comprises an actuator portion, said actuator portion being configured to move between an engaged position in which said lead is secured between and in electrical communication with said first and second securing portions and a disengaged position in which said lead is releasably from between said first and second securing portions.

5. The connector assembly of claim 4, wherein at least a portion of said actuator portion extends outwardly from said housing.

6. The connector assembly of claim 4, wherein at least a portion of said actuator portion is recessable in a portion of said housing.

7. The connector assembly of claim 1, wherein said at least one terminal comprises a first terminal and a second terminal, each of which have one of said leads releasably secured between respective pairs of said first and second securing portions.

8. The connector assembly of claim 2, wherein:
said first housing portion defines at least one first seat extending therefrom;
said second housing portion defines at least one second seat extending therefrom;
said at least one locking member includes at least one shaft extending from said cam portion; and
said at least one shaft being pivotally mounted between said at least one first seat and said at least one second seat.

9. The connector assembly of claim 2, wherein:
said locking mechanism comprises an actuator portion, said actuator portion being configured to move between an engaged position in which said lead is secured between and in electrical communication with said first and second securing portions and a disengaged position in which said lead is releasably from between said first and second securing portions; and
one of said first and second housing portions defines an opening extending therethrough, said actuator portion extending though said opening.

10. The connector assembly of claim 1, wherein said at least one locking mechanism comprising a plurality of said locking mechanisms configured to move independent of one another.
